(19) United States
(12) Patent Application Publication
(10) Pub. No.: US 2020/0170885 A1
(43) Pub. Date: Jun. 4, 2020

(54) PILL SPLITTER

(71) Applicant: Rommy Ahmed, New York, NY (US)

(72) Inventor: Rommy Ahmed, New York, NY (US)

(21) Appl. No.: 16/699,258

(22) Filed: Nov. 29, 2019

Related U.S. Application Data
(60) Provisional application No. 62/773,171, filed on Nov. 29, 2018.

(51) Int. Cl. A61J 7/00; B26D 3/30; B26D 1/04; B26D 7/01

(52) U.S. Cl. CPC A61J 7/0007; B26D 7/01; B26D 1/04; B26D 3/30

(57) ABSTRACT

A device for splitting a pill comprising a pill splitter, including a base slidingly engaged with a jaw. The base and the jaw each include a cutting edge. The jaw slidingly engages to the base to permit the jaw and base to slide and allow the cutting edge of the jaw and the base to split a pill. A lid pivotally engages to the pill splitter to retain the pill within an interior space while two or more flexible guides positioned on a pair of central portions retain the pill in a suitable position to split the pill via the cutting edge. The suitable position of the guides is achieved via a plurality of levers to retain the pill in a central region of the pill splitter.

### CROSS-REFERENCE TO RELATED APPLICATIONS

The present application claims the benefit of U.S. Provisional Patent Application No. 62/773,171, filed Nov. 29, 2018, which is incorporated by reference herein in its entirety.

### TECHNICAL FIELD

The embodiments generally relate to devices constructed to cut an object and, more specifically, relates to devices for cutting pills.

### BACKGROUND

It is well known in the medical profession that drugs are often administered in partial dosages, such as a half dose. For this reason, many medications are manufactured having a score or other marking to indicate and facilitate where a split of the medication can be made. Often, patients utilize their hands, a kitchen knife, or some other type of cutlery to divide a pill for the intended dose. These crude methods result in an inconsistent dosage and may also preclude the patient from being able to take a partial dose of the medication.

In the current arts, many pill cutting devices are difficult to use and often perform an inaccurate split of the pill, which results in an inaccurate dosage for the patient. Many of these devices use a blade affixed to a pivoting lever to cut the pill, which can often cause the pill to break at an angle, unevenly, or to break into multiple pieces.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments disclosed herein relate to a device for splitting a pill, comprising a pill splitter having a base slidingly engaged with a jaw, the base and the jaw each including a cutting edge. The jaw is slidingly engaged to the base to permit the jaw and base to slide and allow the cutting edge of the jaw and the base to split a pill. A lid is pivotally engaged to the pill splitter to retain the pill within an interior space. Two or more flexible guides are positioned on a pair of central portions to retain the pill in a suitable position to split the pill via the cutting edge. The suitable position is configurable via a plurality of levers to retain the pill in a central region of the pill splitter.

The device permits a user to easily, accurately, and consistently split a pill in various configurations to allow the user to consume partial doses of the pill. This provides the advantage of increased safety when consuming partial doses of the pill as well as allowing compromised patients to split a pill who would otherwise be incapable of doing so without great difficulty or while ensuring it is completed accurately and consistently.

In one aspect, each of the plurality of levers are engaged with the bottom side of the pill splitter.

In one aspect, each of the plurality of levers are labelled with a unique indicator.

In one aspect, the lid, the base, and the jaw form an at least semi-sealed chamber in an extended configuration.

In one aspect, the lid, the base, and the jaw form an at least semi-sealed configuration in a contracted configuration.

In one aspect, the lid is pivotally engaged via a threaded screw.

In one aspect, the base is fixed and the jaw is permitted to slide on a pair of tracks formed on the base.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a top plan view of the pill splitting apparatus having the lid in an open configuration, according to some embodiments;

FIG. 2 illustrates a side elevation view of the pill splitting apparatus having the lid in an open configuration, according to some embodiments;

FIG. 3 illustrates a side elevation view of the pill splitting apparatus having the lid in an open configuration, according to some embodiments;

FIG. 4 illustrates an exploded view of the pill splitting apparatus, according to some embodiments;

FIG. 5 illustrates a top plan view of the pill splitting apparatus, according to some embodiments;

FIG. 6 illustrates a perspective view of the pill splitting apparatus, according to some embodiments;

FIG. 7 illustrates a perspective view of the pill splitting apparatus having a flexible guide, according to some embodiments;

FIG. 8 illustrates a perspective view of the pill splitting apparatus having a flexible guide, according to some embodiments;

FIG. 9 illustrates a perspective view of the pill splitting apparatus having levers on the bottom side of the apparatus, according to some embodiments;

FIG. 10 illustrates a perspective view of the pill splitting apparatus having a pill positioned between the jaw and the base to suitably split the pill, according to some embodiments; and

FIG. 11 illustrates a perspective view of the pill splitting apparatus with the pill split within the interior space, according to some embodiments.

### DETAILED DESCRIPTION

The specific details of the single embodiment or variety of embodiments described herein are to the described system and methods of use. Any specific details of the embodiments are used for demonstrative purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second”, “top” and bottom”, and the like, may be used solely to distinguish one entity or element from another entity or element without necessarily requiring or implying any physical or logical relationship or order between such entities or elements.

In general, the embodiments described herein relate to an apparatus for cutting a pill to permit a user to easily split a pill in various configurations. The apparatus allows for a user to consistently split a pill in various configurations to allow the user to consume desired partial doses of the pill.

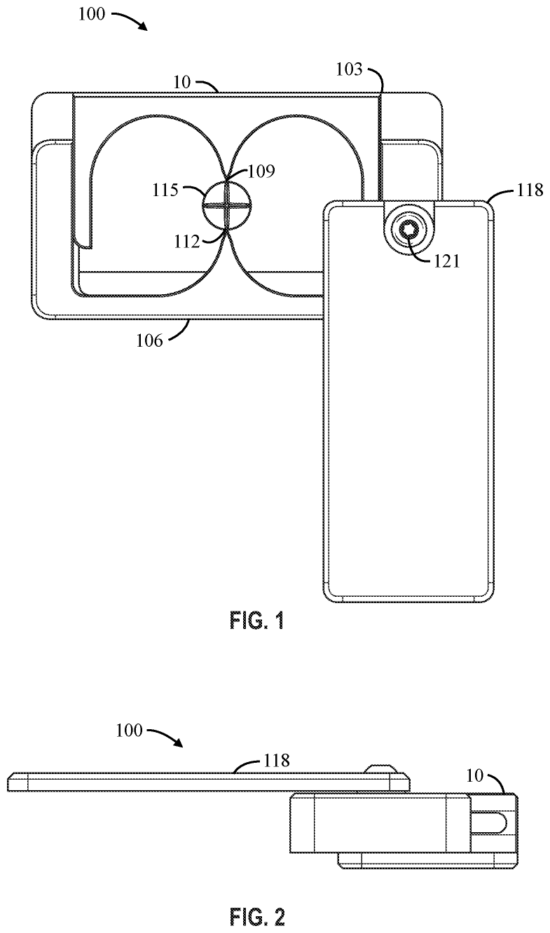

In reference to FIG. 1, the pill splitter 10 apparatus 100 comprises a sliding jaw 103 bound to a base 106. The jaw 103 and base 106 each comprise a cutting edge 109,112 which slide toward one another to cut the pill 115. In one example, each cutting edge 109,112 slide toward one another to about 1 mm separates the two cutting edges 109,112 resulting in the pill splitting at a 90° angle. The cutting edge on the base and the cutting edge on the jaw are parallel to the sliding (travel) direction of the sliding jaw. The jaw 103 is positionable between an open position and a closed position via the sliding motion. A lid 118 is pivotally engaged to rotate via a pivot 121 to permit the rotation of the lid 118 to, at least partially, seal the pill 115 within the apparatus 100.

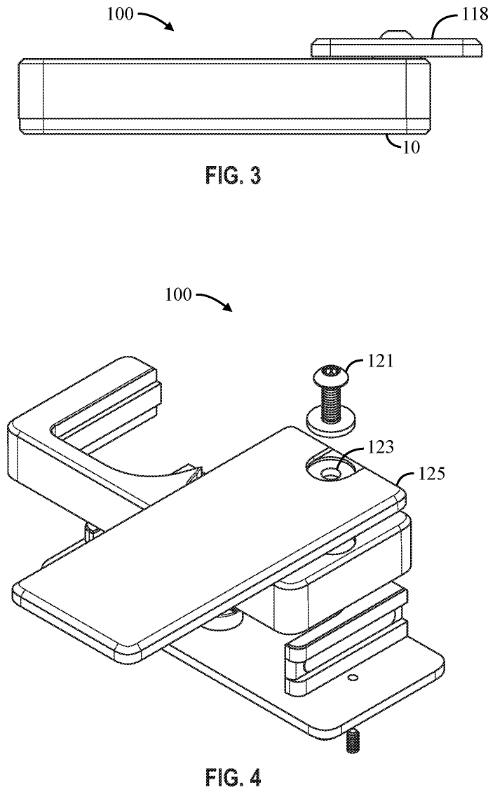

FIG. 2 and FIG. 3 illustrate a side elevation view of the apparatus 100 having the lid 118 and pill splitter 10 in an extended configuration wherein the pill may be disposed between the jaw and the base to effectively split the pill.

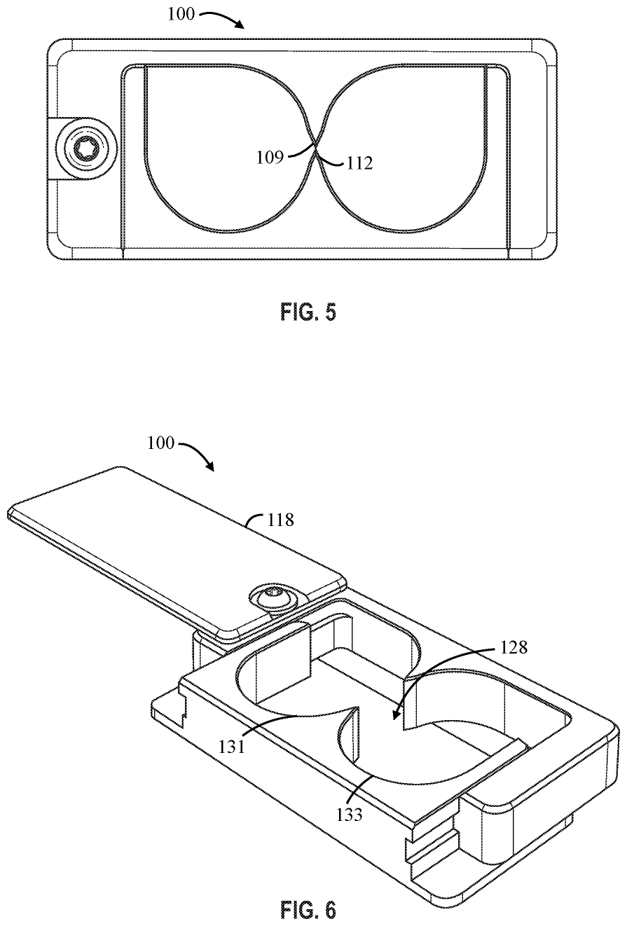

FIG. 4 illustrates an exploded view of the apparatus 100 having the pivot 121 protruding through a series of apertures 123 disposed on a side 125 of each of the lid 118 and the pill splitter 10 to permit the lid 118 to rotate over the pill splitter 10.

FIG. 5 illustrates a top plan view of the apparatus 100 in a contracted configuration such that the first cutting edge 109 and the second cutting edge 112 slide toward one another to effectively split a pill if positioned between the first cutting edge 109 and the second cutting edge 112. As illustrated, the first cutting edge 109 is the top edge formed on the jaw while the second cutting edge 112 is formed on the base.

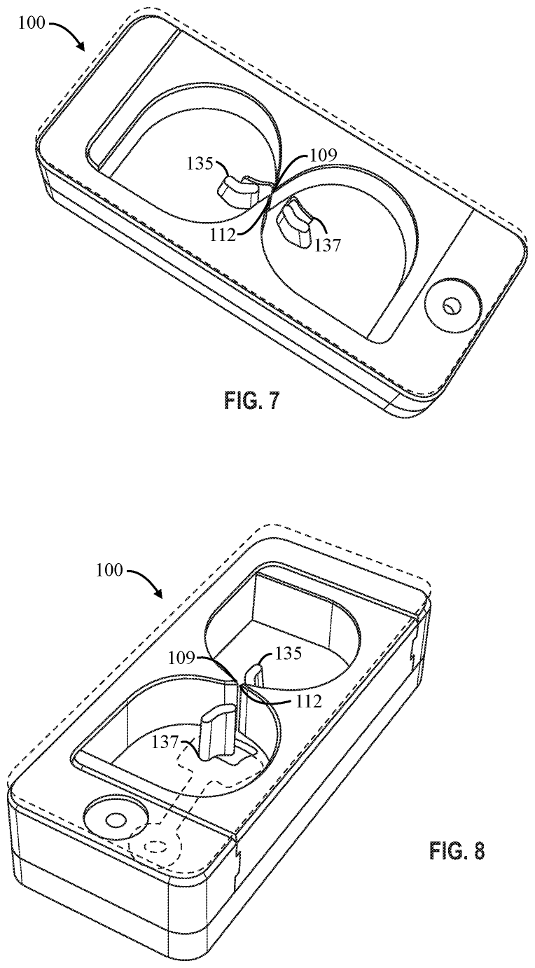

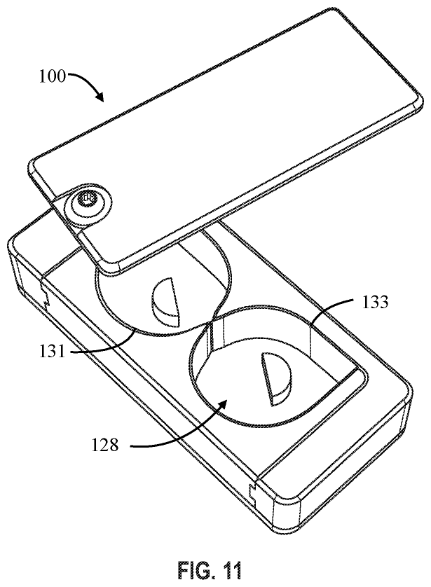

FIG. 6, FIG. 10, and FIG. 11 illustrate a perspective view of the apparatus 100 having an interior space 128 wherein a pill 115 (shown in FIGS. 10-11) may be disposed to effectively split the pill. The pill is positioned within the interior space 128 and is split with the cutting edges to split the pill between the left portion 131 and right portion 133 of the apparatus 100.

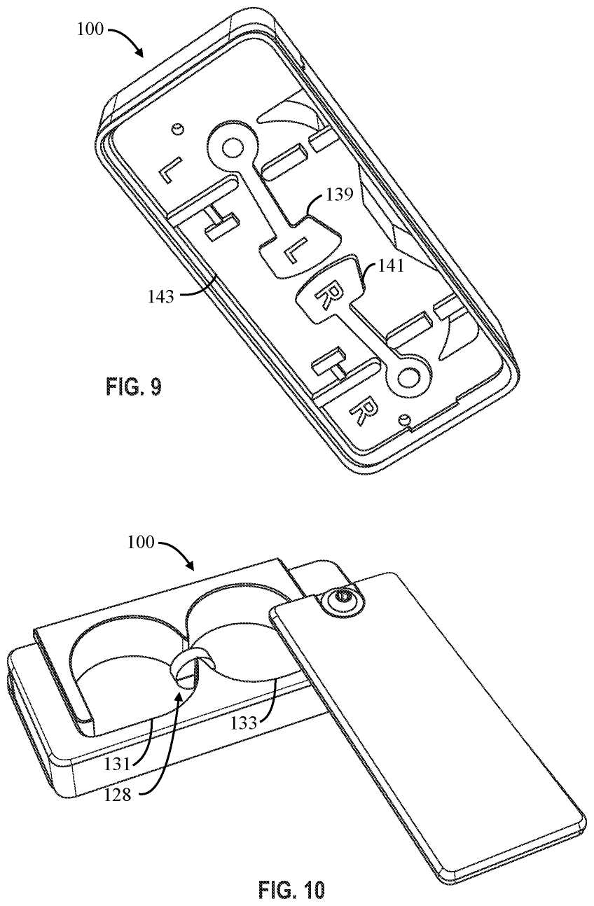

FIG. 7 and FIG. 8 illustrate a pair of flexible guides 135,137 positioned in the left portion 131 and right portion 133 respectively to center the pill in reference to the first and second cutting edges 109,112. Each of the flexible guides 135,137 is retained in position via levers 139 and 141 illustrated in FIG. 9 showing the backside 143 of the apparatus 100. Each lever 139,141 moves each respective guide 135,137 to center the pill to facilitate an accurate split of the pill.

Many pill splitters currently available result in the current arts cause pills to be split at irregular angles, resulting in inaccurate dosing of the pill. The embodiments provides herein result in the pill splitting at a 90° angle to produce a consistent split of the pill. Each guide maintains the pill above the cutting edge on the base such that pressure from the jaw cutting edge is applied by the user. The jaw cutting edge comes in contact with the pill resting on the flexible guides to apply a pressure which pushes the pill along with the flexing guides into the cutting edge of the base, producing a split pill.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A device for splitting a pill, comprising:
a pill splitter comprising a base slidingly engaged with a jaw, the base and the jaw each including a cutting edge, the jaw slidingly engaged to the base to permit the jaw and base to slide to permit the cutting edge of the jaw and the base to split a pill at a 90° angle;
a lid pivotally engaged to the pill splitter to retain the pill within an interior space; and
two or more flexible guides positioned on a pair of central portions to retain the pill in a suitable position to split the pill via the cutting edge.

2. The device of claim 1, further comprising a plurality of levers to adjust and retain the pill in a central region of the pill splitter.

3. The device of claim 2, wherein each of the plurality of levers is engaged with a bottom side of the pill splitter.

4. The device of claim 3, wherein each of the plurality of levers is labeled with a unique indicator.

5. The device of claim 4, wherein the lid, the base, and the jaw form an at least semi-sealed chamber in an extended configuration.

6. The device of claim 5, wherein the lid, the base, and the jaw form an at least semi-sealed chamber in a contracted configuration.

7. The device of claim 1, wherein the lid is pivotally engaged via a threaded screw.

8. The device of claim 1, wherein the base is fixed and the jaw is permitted to slide on a pair of tracks formed on the base.

9. A device for splitting a pill, comprising:
a pill splitter comprising a base slidingly engaged with a jaw, the base and the jaw each including a cutting edge, the jaw slidingly engaged to the base to permit the jaw and base to slide to permit the cutting edge of the jaw and the base to split a pill;
a lid pivotally engaged to the pill splitter to retain the pill within an interior space; and
two or more flexible guides positioned on a pair of central portions to retain the pill in a suitable position to split the pill via the cutting edge, the suitable position configurable via a plurality of levers to adjust and retain the pill in a central region of the pill splitter.

10. The device of claim 9, wherein each of the plurality of levers is engaged with the bottom side of the pill splitter.

11. The device of claim 10, wherein each of the plurality of levers is labeled with a unique indicator.

12. The device of claim 11, wherein the lid, the base, and the jaw form an at least semi-sealed chamber in an extended configuration.

13. The device of claim 12, wherein the lid, the base, and the jaw form an at least semi-sealed chamber in a contracted configuration.

14. The device of claim 9, wherein the lid is pivotally engaged via a threaded screw.

15. The device of claim 9, wherein the base is fixed and the jaw is permitted to slide on a pair of tracks formed on the base.

16. A device for splitting a pill, comprising:
a pill splitter comprising a base slidingly engaged with a jaw, the base including a first cutting edge and the jaw slidingly including a second cutting edge, each of the first and the second cutting edge to permit the jaw and base to slide to permit the first and second cutting edge to split a pill;
a lid pivotally engaged to the pill splitter to retain the pill within an interior space; and
two or more flexible guides positioned on a pair of central portions to retain the pill in a suitable position to split the pill via the first cutting edge and the second cutting edge, the suitable position configurable via a plurality of levers to adjust and retain the pill in a central region of the pill splitter,
wherein the user positions the pill between the first cutting edge and the second cutting edge and provides pressure to slide the jaw to engage the first cutting edge with the second cutting edge to split the pill.

17. The device of claim 16, wherein the lid, the base, and the jaw form an at least semi-sealed chamber in an extended configuration.

18. The device of claim 17, wherein the lid, the base, and the jaw form an at least semi-sealed chamber in a contracted configuration.

19. The device of claim 16, wherein the lid is pivotally engaged via a threaded screw.

20. The device of claim 16, wherein the base is fixed and the jaw is permitted to slide on a pair of tracks formed on the base.
